(19) United States
(12) Patent Application Publication
(10) Pub. No.: US 2012/0048580 A1
(43) Pub. Date: Mar. 1, 2012

(54) POWER TOOL

(75) Inventors: Hans APPEL, Muenchen (DE); Jens Imaschewski, Muenchen (DE); Axel Fischer, Wiedergeltingen (DE)

(73) Assignee: Hilti Aktiengesellschaft, Schaan (LI)

(21) Appl. No.: 12/873,927

(22) Filed: Sep. 1, 2010

(51) Int. Cl. B25D 17/24

(52) U.S. Cl. 173/162.2

(57) ABSTRACT

A handheld power tool has a handle (17), a machine housing (8), in which a drive (4) oscillating along a working axis (5) is situated, and a suspension, which has a first carrier connected to the machine housing (8) and a second carrier connected to the handle (17). A first mating surface of the first carrier facing the machine housing (8) engages behind a second mating surface of the second carrier facing the handle (17). In a basic position, the first mating surface is in contact with the second mating surface under the action of force applied by at least one spring element acting parallel to the working axis (5). The first carrier is displaceable with respect to the second carrier out of the basic position and into a working position along the working axis (5) against the at least one spring element such that, in the working position, an air gap separates the first mating surface from the second mating surface.

### SCOPE OF THE INVENTION

The present invention relates to a handheld power tool having a vibration-isolated handle. Vibration isolation requires soft springs to also isolate the handle from low-frequency vibrations in the machine housing. However, soft springs interfere with secure guidance of the handheld power tool.

### DISCLOSURE OF THE INVENTION

An inventive handheld power tool comprises a handle, a machine housing, in which a drive oscillating along a working axis is situated, and a suspension, which has a first carrier, preferably connected to the machine housing, and a second carrier rigidly connected to the handle. A first mating surface of the first carrier facing the machine housing engages behind a second mating surface of the second carrier facing the handle. In a basic position, the first mating surface is in contact with the second mating surface under the action of force applied by at least one spring element acting parallel to the working axis. The first carrier is displaceable with respect to the second carrier out of the basic position and into a working position along the working axis against at least one spring element such that, in the working position, an air gap separates the first mating surface from the second mating surface. The first mating surface and the second mating surface may be inclined at an angle of at least 70 degrees, e.g., at least 80 degrees to the working axis.

The handle is prestressed by the spring element against the machine housing. The user can press the handle on the machine housing against the force of the spring element or the multiple spring elements connected in parallel or in series. In the working position, the preferably soft spring element has a damping effect. When the user releases the handle, the two mating surfaces become engaged. The suspension becomes stiffer and allows more reliable guidance.

According to one embodiment, the first carrier and/or the second carrier has at least one contact surface, which faces the handle in the case of the first carrier and faces the machine housing in the case of the second carrier. The at least one spring element acts only on the at least one contact surface of the first carrier and/or the second carrier. In the working position, the first carrier and the second carrier are coupled only via the at least one spring element. The contact surfaces may be inclined at an angle of at least 70 degrees, for example, at least 80 degrees or may be perpendicular to the working axis.

The spring element may essentially induce only forces acting along the working axis from the one carrier into the other connected carrier. The spring element does not support the second carrier and thus the handle in directions perpendicular to the working axis. Vibrating forces acting perpendicularly to the working axis, in particular along the longitudinal direction of the handle, are introduced almost completely into another suspension.

According to one embodiment, the spring element contains a damping cushion made of an elastic plastic. The elastic plastic is a foam, for example.

According to one embodiment, the spring element is prestressed in the basic position.

According to one embodiment, the handle is connected by another suspension to the machine housing at a distance in a y direction, which is perpendicular to the working axis, such that the suspension connects the handle to the machine housing along the y direction via another spring element. The additional second suspension supports the handle along the y direction.

According to one embodiment, the handle is connected via another suspension to the machine housing at a distance in a y direction, which is perpendicular to the working axis, and surfaces of the second carrier, which point in the y direction to the additional suspension, are adjacent to a cavity.

According to one embodiment, one of the first mating surface and/or the second mating surface has a lug extending along the working direction, and one other of the first mating surface and/or the second mating surface is supported in the basic position by the lug in a form-fitting manner in a direction perpendicular to the working axis, and in the working position, the one other of the first mating surface and/or the second mating surface is at a distance from the lug along the working axis. The direction perpendicular to the working direction is preferably the direction to the second suspension. In the basic position, the lug keeps the two carriers in position and prevents displacement along the perpendicular direction. As soon as the user presses on the handle, the mating surfaces are displaced to the extent that the lug becomes disengaged from the opposing mating surface. The first suspension is then largely uncoupled from forces along the perpendicular direction.

### BRIEF DESCRIPTION OF THE FIGURES

The following description illustrates the present invention on the basis of exemplary embodiments and figures, in which:

FIG. 1 shows a handheld power tool;

FIGS. 2 to 5 show an upper suspension of a handle;

FIG. 6 shows another embodiment of the upper suspension;

FIG. 7 shows another embodiment of the upper suspension; and

FIG. 8 shows another embodiment of the upper suspension.

Unless otherwise indicated, the same elements or those having the same function are indicated by the same reference numerals in the figures.

### EMBODIMENTS OF THE INVENTION

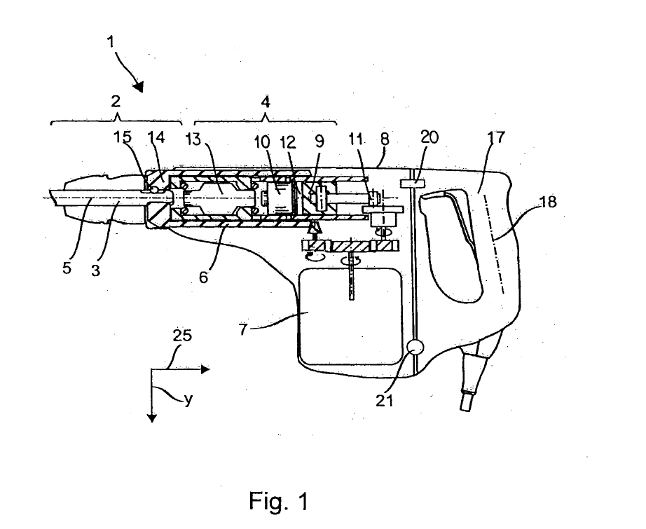

FIG. 1 shows a hammer drill 1 as one embodiment. The hammer drill 1 has a tool holder 2 to hold a drill bit 3. A striking mechanism 4 of the hammer drill 1 periodically strikes the drill bit 3 inserted into the tool holder 2 along a working axis 5 and therefore drives the drill bit into a substrate. Meanwhile, a rotary drive 6 can rotate the drill bit 3 about the working axis 5.

The striking mechanism 4 and the rotary drive 6 can be driven by a shared motor 7, e.g., an electric motor. A machine housing 8 surrounds the striking mechanism 4, the rotary drive 6 and the motor 7, which is optionally shared.

The striking mechanism 4 is a pneumatic mechanism, for example. An exciter 9 and a beater 10 are movably guided along the working axis 5 in the pneumatic striking mechanism 4. The exciter 9 is connected to the motor 7 via a cam 11 or a wobble finger and is forced into a periodic linear motion. A pneumatic spring formed by a pneumatic chamber 12 between the exciter 9 and beater 10 couples a movement of the beater 10 to the movement of the exciter 9. The beater 10 may strike directly on a rear end of the drill bit 3 or may transmit a portion of its momentum to the drill bit 3 indirectly via an essentially stationary intermediate beater 13.

The tool holder 2 has, for example, a sleeve 14 into which the drill bit 3 can be inserted. One or more locking elements 15, e.g., balls, protrude into the sleeve 14 and engage in longitudinally closed grooves in the drill bit 3. The drill bit 3 can slide along the working axis 5 according to the length of its grooves in the tool holder 2. The rotary drive 6 rotates the sleeve 14 about the working axis 5.

The user can guide the hammer drill 1 by hand via a handle 17. The handle 17 is attached to one side of the machine housing 8 facing away from the tool holder 2. A longitudinal axis 18 of the handle 17 runs obliquely or perpendicularly to the working axis 5. For example, the hammer drill 1 may be in mirror symmetry to a plane of symmetry (corresponding to the plane of the drawing) which is spanned by the working axis 5 and the longitudinal axis 18 of the handle 17. An axis perpendicular to the plane of symmetry is hereinafter referred to as the x axis. The y axis is perpendicular to the x axis and to the working axis 5.

A first suspension 20 and a second suspension 21 secure the ends of the handle 17 on the machine housing 8. The handle 17 is preferably arranged asymmetrically with the working axis 5, so that the first suspension 20 is arranged at a smaller distance from the working axis 5 than the second suspension 21. The working axis 5 especially preferably runs through the first suspension 20. The first suspension 20 and the second suspension 21 have damping elements, which dampen a transmission of vibrations of the machine housing 8 to the handle 17.

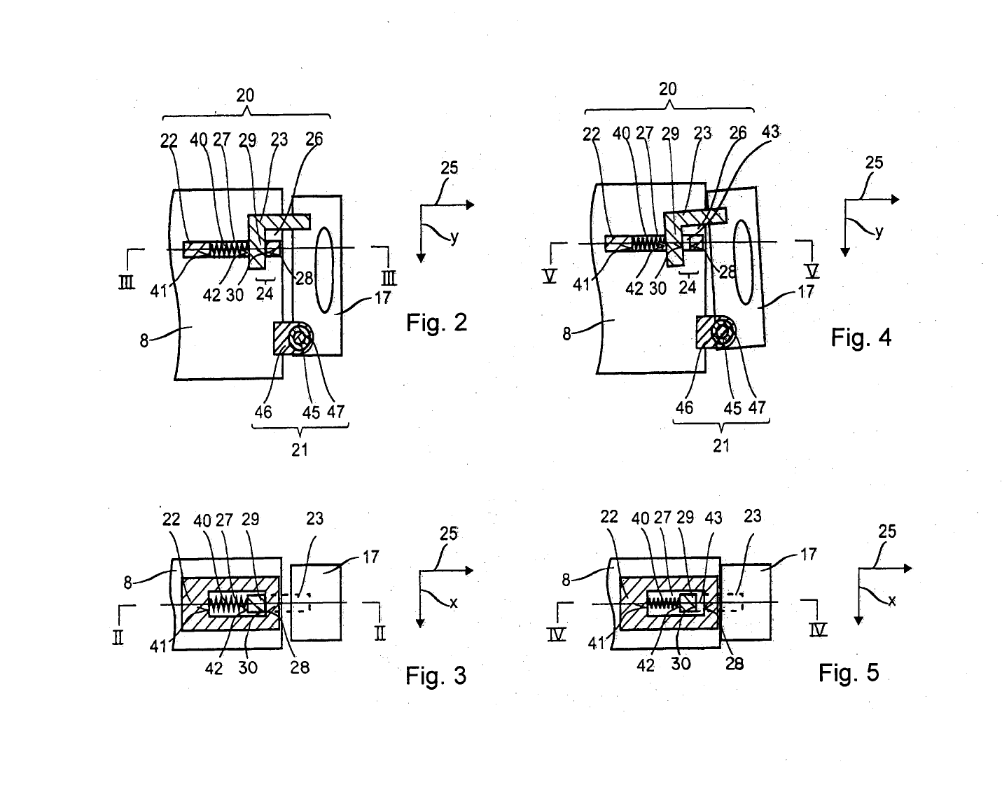

An exemplary embodiment of the first suspension 20 is diagramed in its basic position in a first section in plane II-II in FIG. 2 and in a second section perpendicular to the former in the plane in FIG. 3. FIGS. 4 and 5 show the first suspension 20 in a deflected working position, which it assumes as soon as the user presses the handle 17 toward the machine housing 8 along the working axis 5.

The first suspension 20 has a first carrier 22, which is connected to the machine housing 8, e.g., rigidly, and is preferably not in contact with the handle 17. A second carrier 23 of the first suspension 20 is connected to the handle 17 e.g., rigidly. The second carrier 23 is preferably not in contact with the machine housing 8. The second carrier 23 is movable with respect to the first carrier 22 along the working axis 5. A hook connection 24 of the first carrier 22 with the second carrier 23 limits the freedom of movement of the second carrier 23 in the tension direction 25, i.e., along the working axis 5 at a distance from the machine housing 8. Apart from the inhibiting hook connection 24 in the tension direction 25, the first carrier 22 is not in contact with the second carrier 23. Opposing surfaces of the first carrier 22 and the second carrier 23, which point at least partially in a direction of the y axis, are separated by a first air gap 26. The second suspension 21 holds the two carriers 22, 23 at a distance.

An elongated hole 27 is provided in the first carrier 22, its opening running in a direction perpendicular to the working axis 5, e.g., along the y axis, and its longitudinal extent running parallel to the working axis 5. One end of the elongated hole 27, which is closer to the handle 17, forms a first mating surface 28, which faces the machine housing 8 in a direction along the working axis 5. The first mating surface 28 may be inclined perpendicularly to the working axis 5 or at an angle of at least 70 degrees to the working axis 5.

A journal 29 protrudes away from the second carrier 23 in the direction of the opening of the elongated hole 27 and forms a counterpart to the elongated hole 27 in the hook connection 24. The journal 29 engages in the opening of the elongated hole 27 in the second carrier. A surface of the journal 29 facing the handle 17 forms a second mating surface 30. The second mating surface 30 may be in form-fitting engagement with the first mating surface 28 opposite it. These two surfaces may both be planar, for example. In an alternative embodiment, the one mating surface 28 may have protrusions along the working axis 5 and the other mating surface 30 may have recesses corresponding to the protrusions. The relative movement of the second carrier 23 and also the handle 17 in the tension direction 25 is inhibited when the first mating surface 28 comes to rest against the second mating surface 30 and the two carriers 22, 23 are engaged.

The first suspension 20 contains a spring element 40 which is secured between the first carrier 22 and the second carrier 23. The spring element 40 is in contact with a first contact surface 41 of the first carrier 22, which faces the handle 17 along the working axis 5 and is in contact with a second contact surface 42 of the second carrier 23, which faces the machine housing 8 along the working axis 5. The second contact surface 42 is, for example, on the side of the journal 29 facing away from the second mating surface 30. The first contact surface 41 is formed by the surface of the other end of the elongated hole 27. The spring element 40 exerts a force on the first carrier 22 along the working axis 5 in the direction of the machine housing 8 and exerts a force on the second carrier 23 along the working axis 5 in the direction of the handle 17, i.e., in the tension direction 25. The two carriers 22, 23 are pushed apart by the spring element 40 along the working axis 5 until the two mating surfaces 28, 30 are in contact with one another. The mating surfaces 28, 30, which are in contact with one another, form the resting position or basic position of the first suspension 20, which is assumed as soon as the user is not exerting any force on the handle 17. The handle 17 may be deflected out of the basic position, along the working axis 5, until the spring element 40 is maximally compressed between the two contact surfaces 41, 42.

The spring element 40 may be, for example, a spiral spring whose winding axis runs parallel to the working axis 5. The spiral spring has a great stiffness along the working axis 5 and a much lower stiffness perpendicular to the working axis 5. The length of the spiral spring is at least twice as great as the diameter of the spiral spring, for example. The winding axis preferably lies on the working axis 5.

The mating surfaces 28, 30 are frictionally engaged or they are linked together in a form-fitting manner. The spring element 40 may also be prestressed in the basic position, so that the frictional engagement between the mating surfaces 28, 30 is intensified. The frictional and form-fitting engagement of the mating surfaces 28, 30 that are at least partially perpendicular to the working axis 5 prevents a movement of the first suspension 20 in the direction perpendicular to the working axis 5, in particular along the y axis. The holding force provided by the frictional and form-fitting engagement in one direction perpendicular to the working axis preferably exceeds five times the force supplied by the spring element 40 in this direction.

During operation, the user presses the handle 17 against the machine housing 8 with the second carrier 23 partially along the working axis 5. The suspension 20 goes into a working position. The relative displacement of the second carrier 23 with respect to the first carrier 22, i.e., the first mating surface 28 with respect to the second mating surface 30, along the working axis 5 takes place against the spring force of the spring element 40. The lift depends on the pressing force applied by the user. The two mating surfaces 28, 30 become disengaged and separate from one another. A second air gap 43 separates the two mating surfaces 28, 30. The form-fitting and frictional engagement between the two mating surfaces 28, 30 is canceled. The two carriers 22, 23 are thus coupled together in a frictionally engaged manner only by the spring element 40. The holding force perpendicular to the working axis 5 drops suddenly due to the first suspension 20. The second carrier 23 may provide spring support in the working position in a softer manner than in the basic position in the first air gap 26 perpendicular to the working axis 5. In the working position, the second suspension 21 mainly receives the forces acting perpendicularly to the working axis 5, in particular along the y axis.

FIGS. 2 and 4 show an embodiment of the second suspension 21. The second suspension 21 is designed as a rotary bearing whose axis of rotation is oriented parallel to the x axis. A shaft 45 of the rotary bearing is rigidly connected to the handle 17 and one or more bearing seats 46 are rigidly connected to the machine housing 8. The shaft 45 is inserted into the tubular bearing seats 46. A tube 47 made of an elastic plastic surrounds the shaft 45 inside of the bearing seat 46 and holds the shaft 45 at a distance from the bearing seats 46. The tube 47 may have a uniform wall thickness along its circumference. The second suspension 21 provides spring support in each direction perpendicular to the axis of rotation. The spring force applied by the second suspension 21 along the y axis is preferably greater than the spring force applied by the first suspension 20 along the y axis through the spring element 40.

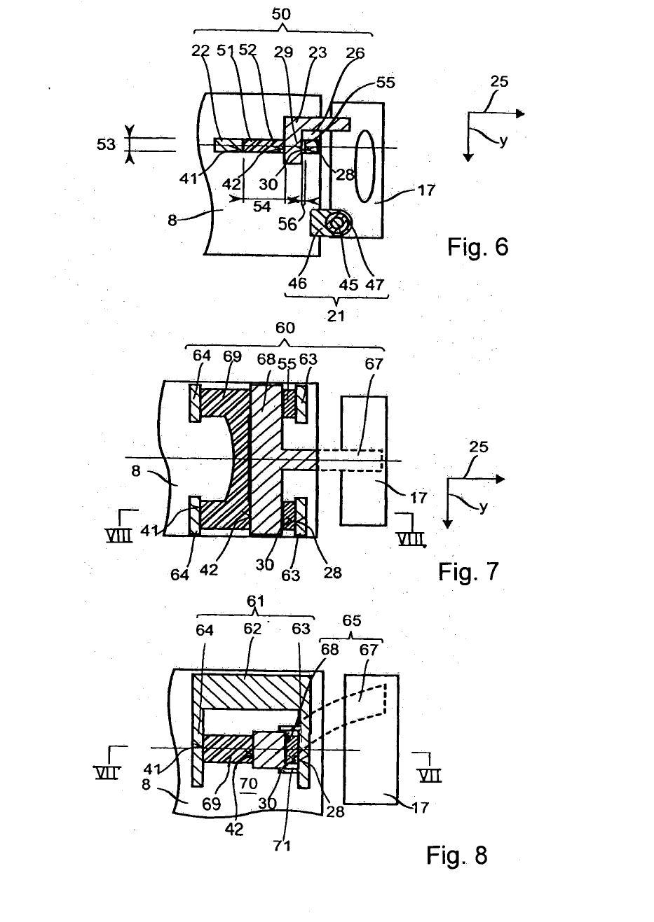

FIG. 6 shows another embodiment of the first suspension 50 which differs essentially from the previous embodiment through the design of the spring element 51. The first suspension 50 has a first carrier 22 and a second carrier 23. The spring element 51 of the first suspension 50 acts on the first carrier 22 and the second carrier 23 in such a way that these carriers 22, 23 are displaced along the working axis 5 into a basic position in which the mating surfaces 28, 30 are in contact with one another. The spring element 51 is preferably arranged coaxially with the working axis 5.

The spring element 51 includes a damping cushion 52 made of an elastic plastic, e.g., a foam. The damping cushion 52 is clamped between the first contact surface 41 of the first carrier 22 and the second contact surface 42 of the second carrier 23. The spring element 51 is prestressed along the working axis 5 in the basic position of the two carriers 22, 23. The spring element 51 is relaxed, i.e., without any acting force, in the directions perpendicular to the working axis 5, in particular in the y direction. The spring element 51 with the otherwise isotropic plastic retains a great stiffness along the working axis 5 due to the direction-dependent prestress, while the spring element 51 is soft in the y direction. However, the prestress causes a collapse of the damping cushion 52, which can be counteracted only through a greater width 53 (dimension in the y direction). This increases the stiffness in the y direction in an undesirable manner. It has surprisingly been found that the gain in stiffness along the working axis 5 due to the prestress overcompensates for the gain in stiffness along the y direction due to the wider damping cushion 52. The damping cushion 52 may have an essentially rectangular cross section parallel to the plane of symmetry of the handheld power tool 1. A dimension 54 (thickness) of the clamped damping cushion 52 parallel to the working axis 5 may be equal to or less than, e.g., up to 50% less than, the dimension 53 (width) of the damping cushion 52 in the y direction.

The second mating surface 30 of the second carrier 23 may be formed by a thin plastic layer 55, for example, made of the same foam as the damping cushion 52. The plastic layer 55 increases the adhesive friction on the first mating surface 28 of the first carrier 22. The thickness 56 (dimension along the working axis 5) of the plastic layer 55 is in the range between 10% and 25% of the thickness 54 of the damping cushion 52. This ensures that the second mating surface 30 is separated from the second carrier 23 when the user presses the handheld power tool 1 against a substrate by using the handle 17.

FIGS. 7 and 8 show an embodiment of the handheld power tool 1 having a different design of the first suspension 60. A first carrier 61 has two shells which are opened in the y direction. The two shells 62 are arranged at a distance from one another in the x direction in the machine housing 8, preferably with the shells 62 bordering an inside wall of the machine housing 8 laterally. The shells 62 each have a front shell wall 64 and a rear shell wall 63, which extend in the y direction and are a distance apart from one another in the working axis 5.

The handle 17 is connected to a second carrier 65. The second carrier 65, preferably having a symmetrical design, has a web 67 which develops into two arms 68 running across the web 67. The web 67 extends into an inter space between the shells 62 of the first carrier 61. The arms 68 of the second carrier engage between the front shell walls 64 and the rear shell walls 63. The surfaces of the front shell walls 64 facing the handle 17 along the working axis 5 form the first contact surfaces 41. The sections of the arms 68 opposite the first contact surfaces 41 form the second contact surfaces 42. The two contact surfaces 41, 42 are largely perpendicular to the working axis 5, e.g., their inclination to the working axis 5 is greater than 70 degrees, in particular in a plane spanned by the working axis 5 and the y direction.

A damping cushion 69 is provided between the front shell walls 64 and the arms 68. The damping cushion 69 may extend in one piece over the entire dimension in the x direction of the arms 68 or may be provided only in the area of the front shell walls 64. The damping cushion 69 is preferably prestressed and is designed to be like the embodiments described previously. In a basic position, one mating surface 28 of the rear shell wall 63 and the opposing mating surfaces 30 of the arms 68 are in contact with one another and are acted upon by force due to the damping cushion 69.

A cavity 70 is connected to the second carrier 65 in the direction of the second suspension (y direction). When the first suspension 60 is observed, the two carriers 61, 65 are linked together only by the contact of the two mating surfaces 28, 30 and the damping cushion 69 acting on contact surfaces 41, 42 that are also only largely perpendicular. The second carrier 65 may thus be deflected only in the y direction against the forces applied by the damping cushion 69 and the holding force between the two mating surfaces 28, 30. As soon as the user separates the two mating surfaces 28, 30 from one another by pressing the handle 17 against the machine housing 8, the force required to deflect the first suspension 60 in the y direction is suddenly reduced.

A lug 71 may protrude from the second mating surface 30 along the working axis 5. The first carrier 61 rests on the lug 71 as long as the first suspension 60 is in the basic position. When the user presses the handle 17 against the machine housing 8, the first mating surface 30 is no longer overlapping the lug 71. The form-fitting connection supporting the first suspension 60 in the y direction is then canceled. The dimension of the lug 71 along the working direction 5 is shorter than the distance by which the damping cushion 69 can be compressed, e.g., is smaller than one-fifth or smaller than one-tenth of this distance.

The preceding embodiments are described with respect to a cutting handheld power tool 1. The suspensions of the handle 17 may likewise be applied to machine housings 8 of other handheld power tools having a linearly oscillating drive, e.g., a reciprocating saw with a cam drive.

1-9. (canceled)

10. A handheld power tool, comprising:
a handle;
a machine housing;
a drive disposed within the machine housing and oscillatable along a working axis; and
a suspension which has a first carrier connected to the machine housing and a second carrier connected to the handle;
wherein a first mating surface of the first carrier facing the machine housing is engageable with a second mating surface of the second carrier facing the handle;
wherein in a basic position, the first mating surface engages the second mating surface by a force applied by a spring element acting parallel to the working axis;
and wherein in a working position, the first mating surface does not engage the second mating surface such that an air gap separates the first mating surface from the second mating surface.

11. The handheld power tool according to claim 10, wherein the first carrier has a contact surface which faces the handle and the second carrier has a contact surface that faces the machine housing, wherein the spring element is disposed between the respective contact surfaces, and wherein in the working position the first carrier and the second carrier are coupled only via the spring element.

12. The handheld power tool according to claim 10, wherein the first mating surface and the second mating surface are inclined at an angle of at least 70 degrees to the working axis.

13. The handheld power tool according to claim 11, wherein the respective contact surfaces are inclined at an angle of at least 70 degrees to the working axis.

14. The handheld power tool according to claim 10, wherein the spring element contains a damping cushion made of an elastic plastic.

15. The handheld power tool according to claim 10, wherein the spring element is prestressed in the basic position.

16. The handheld power tool according to claim 10, further comprising a second suspension, wherein the handle is connected to the machine housing via the second suspension at a distance in a direction which is perpendicular to the working axis, and wherein the second suspension connects the handle to the machine housing via a second spring element.

17. The handheld power tool according to claim 10, further comprising a second suspension, wherein the handle is connected to the machine housing via the second suspension at a distance in a direction which is perpendicular to the working axis, and wherein surfaces of the second carrier which point in the direction to the second suspension are adjacent to a cavity.

18. The handheld power tool according to claim 10, wherein a one of the first mating surface and the second mating surface has a lug extending along the working axis and an other of the first mating surface and the second mating surface is supported in the basic position by the lug in a form-fitting manner in a direction perpendicular to the working axis, and wherein in the working position the other of the first mating surface and the second mating surface is at a distance from the lug along the working axis.
